(19) United States
(12) Patent Application Publication
(10) Pub. No.: US 2025/0366408 A1
(43) Pub. Date: Dec. 4, 2025

(54) SOLAR INLINE FAN INTEGRATED ORGANIC SOIL BED SYSTEM

(71) Applicants: Brian Roy Lund, Redmond, WA (US); Bryan Guy, Seattle, WA (US); Michael Roelfs, Seattle, WA (US)

(72) Inventors: Brian Roy Lund, Redmond, WA (US); Bryan Guy, Seattle, WA (US); Michael Roelfs, Seattle, WA (US)

(21) Appl. No.: 19/295,995

(22) Filed: Aug. 11, 2025

Related U.S. Application Data
(63) Continuation of application No. 17/716,803, filed on Apr. 8, 2022, now Pat. No. 12,382,880.
Application No. 17/716,803 is a continuation-in-part of application No. 17/398,223, filed on Aug. 10, 2021, now Pat. No. 11,297,779.
(60) Provisional application No. 63/064,599, filed on Aug. 12, 2020.

(51) Int. Cl. A01G 9/02; A01G 7/02; A01G 9/24

(52) U.S. Cl. CPC A01G 9/02; A01G 7/02; A01G 9/24

(57) ABSTRACT

A solar inline fan integrated true living organic (TLO) plant growing system that allows soil to be reused for every new growth cycle. In one aspect, the TLO plant growing system of the solves the problem of preventing opportunities for anaerobic micro-organism activity from building up within the soil thereby creating toxic chemicals that kill microbes beneficial to the growth of the plant. Specifically, the TLO system includes an aerated chamber between the bottom of the bed and the soil that the plants are growing to provide oxygen, carbon dioxide, water, and moisture to the TLO soil and plants and to promote optimal growing conditions, among other advantages.

### CROSS-REFERENCE TO RELATED APPLICATIONS

This application is a continuation-in-part of U.S. Non-Provisional application Ser. No. 17/716,803 filed on Apr. 8, 2022, which is incorporated herein by reference in its entirety, which is a continuation-in-part of U.S. Non-Provisional application Ser. No. 17/398,223 filed on Aug. 10, 2021, which is incorporated herein by reference in its entirety, which claims the benefit of U.S. Provisional Application No. 63/064,599 filed on Aug. 12, 2020, which is incorporated herein by reference in its entirety.

### BACKGROUND

This section is intended to introduce the reader to aspects of art that may be related to various aspects of the present disclosure described herein, which are described and/or claimed below. This discussion is believed to be helpful in providing the reader with background information to facilitate a better understanding of the various aspects of the present disclosure described herein. Accordingly, it should be understood that these statements are to be read in this light, and not as admissions of prior art.

True living organic (TLO) soil or organic soilless medium is generally soil that is alive with microbiology that feeds the plant as nature intended, such as beneficial fungi, bacteria, and various microbes. Generally, the root system of a plant sends chemical signals, called exudates, to the micro-organisms in the soil where they exchange nutrients in a symbiotic relationship. The soil's ecosystem, also known as the soil food web, is a hierarchy of micro-organisms that work symbiotically with a plant in order to help the plant grow optimally. Optimal soil maintenance starts with mitigating opportunities for anaerobic micro-organism activity from building up within the soil thereby creating toxic chemicals that kill microbes beneficial to the growth of the plant. This build up often happens at the bottom of the bed, where the roots, soil, and water coalesce.

After a growth cycle of a traditional potted plant, the conventional method is to dispose of the used and depleted soil and plant new soil for another growth cycle. However, this conventional method is not only wasteful and uneconomical, but can also slow the growth cycle of the next plant.

Hence, what is needed is a method, system, and apparatus that allows one to reuse the soil for every new growth cycle of a plant, thereby creating a microbe abundant and nutrient rich soil which promotes faster and healthier plant growth for every growth cycle and further reducing wasteful disposal of soil.

### BRIEF SUMMARY

In one aspect of the disclosure described herein, a true living organic (TLO) plant growing system is disclosed that allows soil to be reused for every new growth cycle. In one aspect, the TLO system of the disclosure described herein solves the problem of preventing opportunities for anaerobic micro-organism activity from building up within the soil thereby creating toxic chemicals that kill microbes beneficial to the growth of the plant while simultaneously allowing oxygen to penetrate the bottom of the soil. Specifically, the TLO system creates an aerated chamber between the bottom of the bed and the soil that the plants are growing in. Hence, the TLO system of the disclosure described herein allows for the soil to stay in its bed indefinitely as the soil microbiology improves over time. Further, one or more casters under the bed allow it to be moved in and out of different growing environments, thereby providing versatility and an increased ability to hone the environment to what the plants need at that point in their growth cycle. The ability to use a soil over and over for the same crop helps the crop being grown to feel “at home” right away with the micro life that is specifically propagated and created over time in that soil which optimizes the plant's growth. Accordingly, the ability to reuse the soil saves time and money because one does not have to dispose of the toxic, unusable soil after the growth cycle is complete, thereby saving time, labor, and costs.

In another aspect of the disclosure described herein, the TLO system of the disclosure described herein can be a plug and play (or modular) true living organic soil bed growing structure and system which can be mounted on multiple castors or wheels. This allows mobility of the plant growing pods within and between various growing environments. It can also be used as a single standalone system or grouped together in a larger warehouse type configuration, which allows for the maximum efficiency in utilizing space and resources. Here, the TLO system of the disclosure described herein can include but is not limited to a 4′×4′ or 4′×8′ pod or bin that is a thriving ecosystem with a focus on plug and play (or modular) components that are interchangeable between other pods. The pod itself is designed to maintain the ideal TLO soil and atmospheric conditions necessary to keep the TLO soil's microbiology alive, thriving, and improving over time.

In addition, the TLO system of the disclosure described herein includes a soil platform that creates the eco-chamber that is an air circulation system configured to allow natural flowing air or pushed air through the eco-chamber below the soil. Hence, this allows the TLO soil to maintain its organic microbiology while, at the same time, preventing the otherwise inevitable buildup of harmful toxins and unwanted pests/predators that are attracted to the anaerobic and toxic environment that traditionally deteriorates soil, making it unusable. Here, not only does the system allow for the continuous use of the same TLO soil crop after crop, the crop itself communicates with the micro life in the TLO soil. The constant and continuing interaction between the plant's roots system and the micro life in the TLO soil allows for the plant to improve the TLO soil and the soil to improve the plant over time. The quality of TLO soil will increase, but, so too, does the consistency in crop production and quality because the TLO soil is continually tuned by and for that specific plant that is planted.

In particular, the TLO system of the disclosure described herein is able to combine oxygen (O₂) circulation under the soil's beds, an O2 vertical flow system, a targeted CO₂ delivery system, an above the plant air circulation and exhaust system, photon reflective and atmospheric side panels, a bungee style plant support system (e.g., a trellis), and a versatile light mounting system to provide an economical, efficient, and effective plant growing system. In another aspect of the disclosure described herein, the TLO system can include a bin that houses a soil platform that supports the soil and creates an aerated region below the soil, a vertical oxygen flow module, a carbon-dioxide injection module, a fan module, a watering module, and a lighting module. In another aspect of the disclosure described herein, the TLO system includes a housing having soil disposed therein and an open aerated region under the soil, a bin that houses a soil platform that supports the soil and creates an aerated region below the soil.

In another aspect of the disclosure described herein, a true living organic soil system is disclosed having a housing, an oxygen dispensing module or unit, a carbon dioxide dispensing module or unit, a watering module or unit, and a lighting module or unit. The system may also include soil disposed within the housing and an open aerated region under the soil. Further, the oxygen dispensing module can include a plurality of tubes that extend from an upper region of the housing to the lower region of the housing. In addition, the carbon dioxide dispensing module can include a plurality of tubes that extend from an upper region to the top of the soil within the housing. The system may also include a circulation fan module, wherein the circulation fan module can be configured to divert carbon dioxide gases released from the carbon dioxide module upwards. In addition, the oxygen dispensing module can further include a fan injection unit. The system may also include a support platform disposed within the housing. Here, the support platform can include a grid or lattice configuration. In addition, the support platform can further include an open aerated area underneath, such that the open aerated area under the support platform receives oxygen gas.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates a perspective view for one non-limiting exemplary embodiment of the TLO planting growing system and apparatus of the disclosure described herein.

FIG. 2A illustrates a simplified top view of the TLO plant growing system, method, and apparatus of the disclosure described herein, illustrating an oxygen (O₂) circulation system.

FIG. 2B illustrates a simplified cross-sectional side view for the drawing of FIG. 2A.

FIG. 2C illustrates a simplified front view for the drawing of FIG. 2A.

FIG. 3A illustrates another simplified top view of the TLO plant growing system, method, and apparatus of the disclosure described herein, further illustrating a targeted carbon dioxide (CO₂) delivery system and a vertical O₂ flow system.

FIG. 3B illustrates a simplified cross-sectional side view for the drawing of FIG. 3A.

FIG. 3C illustrates a simplified front view for the drawing of FIG. 3A.

FIG. 4A illustrates another simplified top view of the TLO plant growing system, method, and apparatus of the disclosure described herein, further illustrating an exhaust and lighting system.

FIG. 4B illustrates a simplified cross-sectional side view for the drawing t of FIG. 4A.

FIG. 4C illustrates a simplified front view for the drawing of FIG. 4A.

FIG. 5A illustrates another simplified top view of the TLO plant growing system, method, and apparatus of the disclosure described herein, further illustrating a moisture and humidity control system.

FIG. 5B illustrates a simplified cross-sectional side view for the drawing of FIG. 5A.

FIG. 5C illustrates a simplified front view for the embodiment of FIG. 5A.

FIG. 6A illustrates a top view of the TLO plant growing system, method, and apparatus of the disclosure described herein.

FIG. 6B illustrates a cross-sectional side view for the TLO plant growing system, method, and apparatus of the disclosure described herein.

FIG. 7A illustrates a side view for the TLO plant growing system, method, and apparatus of the disclosure described herein.

FIG. 7B illustrates a bottom view for the TLO plant growing system, method, and apparatus of the disclosure described herein.

FIG. 8A illustrates bottom perspective view of a platform support for the TLO growing system, method, and apparatus of the disclosure described herein.

FIG. 8B illustrates a top view of the platform support apparatus of FIG. 8A.

FIG. 9 illustrates a block diagram for one non-limiting exemplary embodiment of a network architecture for automating the TLO plant growing system, method, and apparatus of the disclosure described herein.

FIG. 10 illustrates a perspective view for a solar inline fan injection unit of the disclosure described herein, according to one non-limiting exemplary embodiment.

FIG. 11A illustrates a front view for the solar inline fan injection unit of the disclosure described herein.

FIG. 11B illustrates a rear view for the solar inline fan injection unit of the disclosure described herein.

FIG. 12A illustrates a left side view for the solar inline fan injection unit of the disclosure described herein.

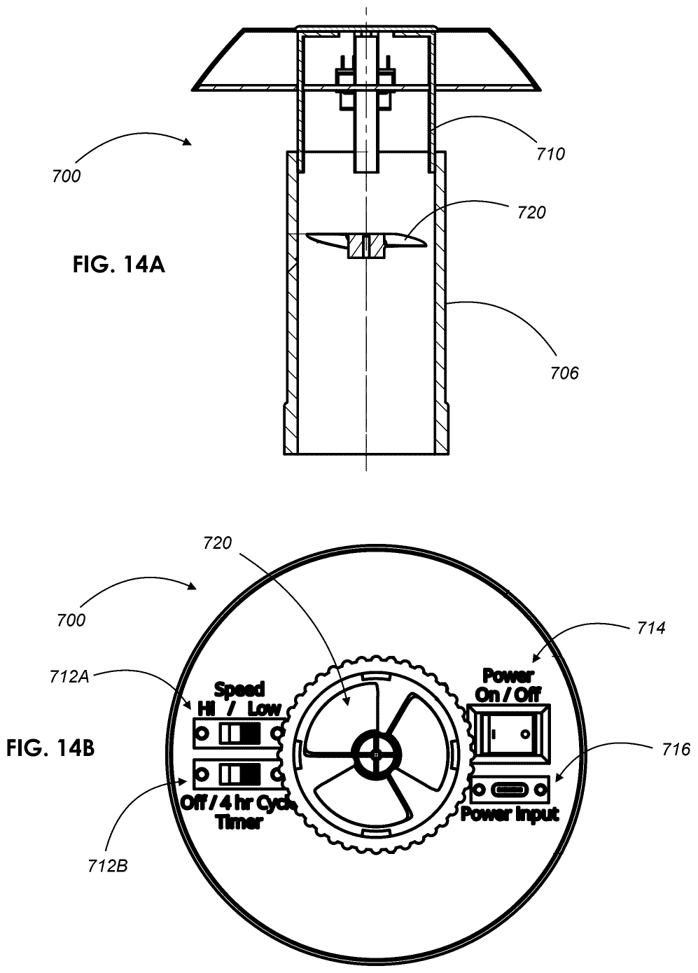

FIG. 11B illustrates a right side view for the solar inline fan injection unit of the disclosure described herein.

FIG. 13A illustrates a top view for the solar inline fan injection unit of the disclosure described herein.

FIG. 13B illustrates a bottom view for the solar inline fan injection unit of the disclosure described herein.

FIG. 14A illustrates a simplified cross-sectional side view for the solar inline fan injection unit of the disclosure described herein.

FIG. 14B illustrates a simplified bottom view for the solar inline fan injection unit of the disclosure described herein.

### DETAILED DESCRIPTION

In the Brief Summary of the present disclosure above and in the Detailed Description of the disclosure described herein, and the claims below, and in the accompanying drawings, reference is made to particular features (including method steps) of the disclosure described herein. It is to be understood that the disclosure of the disclosure described herein in this specification includes all possible combinations of such particular features. For example, where a particular feature is disclosed in the context of a particular aspect or embodiment of the disclosure described herein, or a particular claim, that feature can also be used, to the extent possible, in combination with and/or in the context of other particular aspects and embodiments of the disclosure described herein, and in the disclosure described herein generally.

The embodiments set forth below represent the necessary information to enable those skilled in the art to practice the disclosure described herein and illustrate the best mode of practicing the disclosure described herein. In addition, the disclosure described herein does not require that all the advantageous features and all the advantages need to be incorporated into every embodiment of the disclosure described herein.

In one implementation of the disclosure described herein, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., an iPhone®, Android®, or any “smart phone”), a personal computer, iPad®, server computer, or laptop computer; personal digital assistants (PDAs), such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including Bluetooth®, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, features, options, and/or attributes of the disclosure described herein. For example, the portal can be a web page accessed with a web browser, mobile device application, or any application or software residing on a computing device.

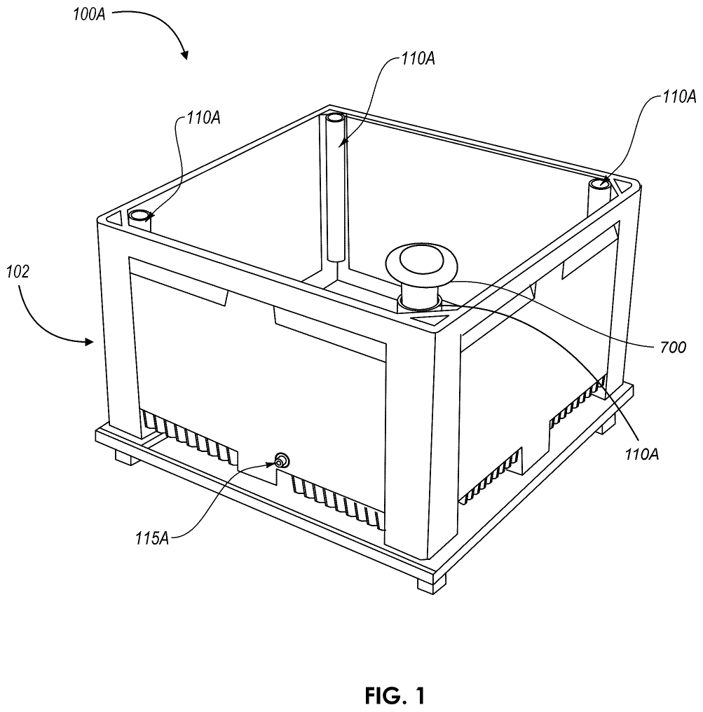

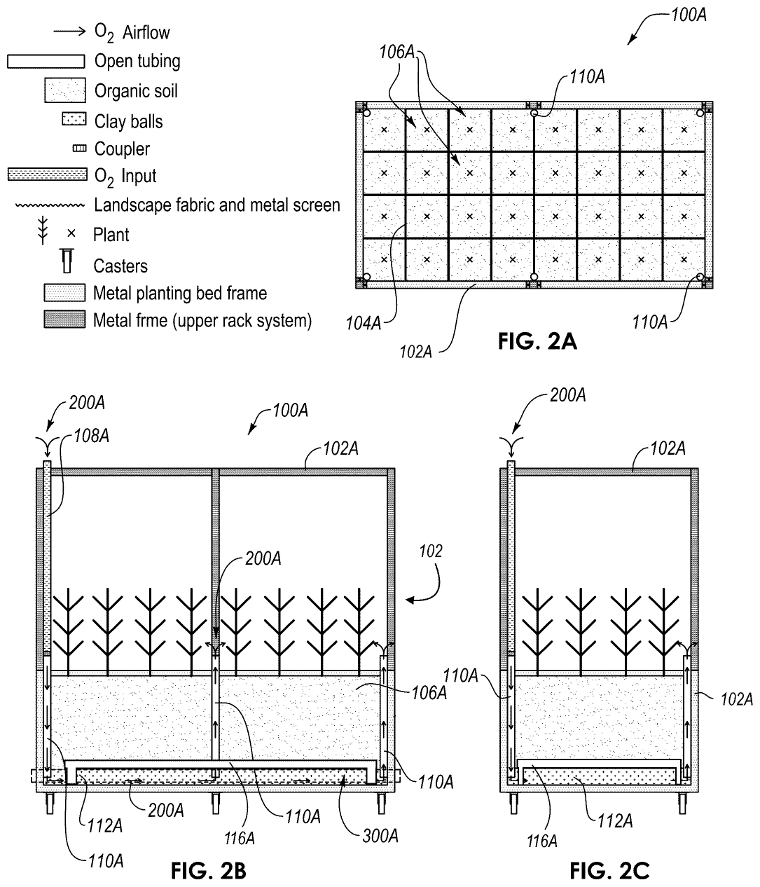

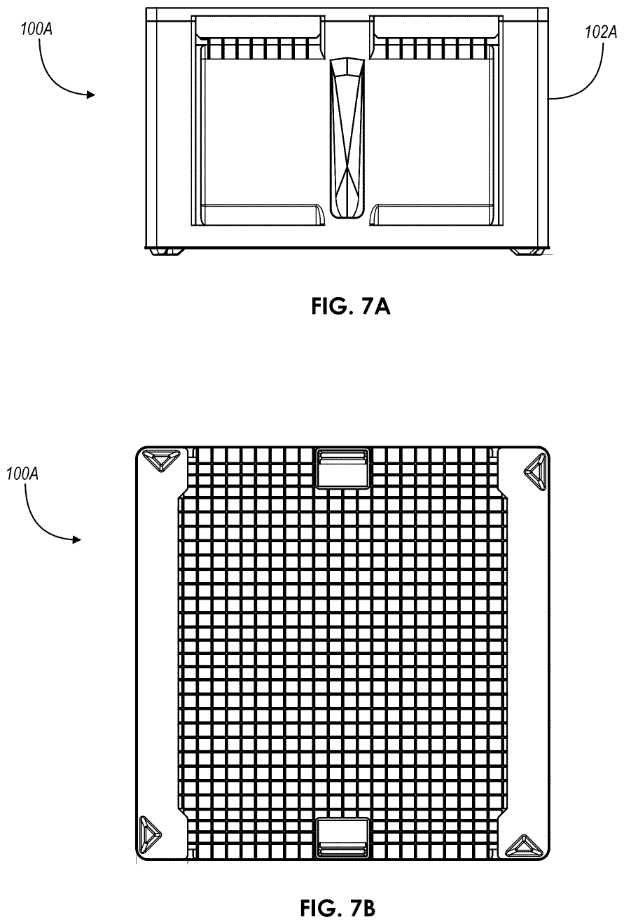

FIGS. 1-8B illustrate one or more non-limiting embodiments of the TLO system, method, and apparatus of the disclosure described herein. TLO system and pod 100A of the disclosure described herein can include a framed metal open-top (or enclosed top) casing or housing 102. Pod 100A can further include a plurality of piping or tubing 110A to assist with distributing or exhausting oxygen or carbon dioxide within pod 100A, and a drain plug 115A for dispensing water, sludge, or fluid contents from within pod 100A. Referring to FIGS. 2A-2C, one embodiment for an oxygen injection and circulation system via a pressurized tubing system (or alternatively an inline fan injection system) is shown. Here, the TLO system and pod 100A can include TLO soil 106A with seeds or plants planted therein and disposed in a lower half region of the framed housing or pod. The housing 102 can include a modular top and lower tier rack frame 102A secured together and connected to vertical posts. Alternatively, frame 102A may be one unitary component or multiple modular pieces integrated and secured together. In addition, frame 102A may also include rolling casters to assist with moving the TLO system and pod to various environments.

Still referring to FIGS. 2A-2C, the TLO system and pod 100A can also include an oxygen (O₂) injection and circulation system. Specifically, tubing 108A can be secured along the upper region of frame 102A of the TLO system (such as along one of the vertical posts) that further extends towards the lower region of frame 102A, that can allow oxygen 200A to be sent via pressurized tubing, or alternatively, or in addition to, via a solar-powered inline fan injection unit, device, or system 700 directly below the soil platform 116A to the bottom open region of 300A (eco-chamber) to propagate through the TLO soil from the bottom toward the top. Here, tubing 108A, including the solar-powered inline fan injection system 700, can be further connected to a series of additional tubing 110A that extends to the lower region of frame 102A and be further disposed in and around the frame of the TLO system and pod such as in the corner regions and mid-regions, as shown in FIG. 2A. It is contemplated within the scope of the present disclosure described herein that tubing 108A and 110A can be integrated as one tube or pipe. Here, tubing 110A allows the fresh oxygen 200A to be injected to the open space chamber or region 300A below the TLO soil. Specifically, region 300A can be an open-air cavity or chamber that allows oxygen to flow therethrough below the TLO soil. In one embodiment, region 300A can include clay balls 112A having a wired mesh layer to further help support the TLO soil above it and further evenly distribute and propagate the injected oxygen throughout the cavity. In addition, a soil platform support or lattice structure 116A may be disposed in the cavity region 300A. For example, any type of a support platform, cross-lattice structure, porous structure, or open-pore cellular foam structure may be disposed within region 300A, such as platform 116A, that can not only support the weight of the TLO soil 106A above it, but also assist with evenly distributing and propagating the injected oxygen within the bottom region 300A. In addition, tubing 110A can also assist with distributing or exhausting the oxygen to the surface of the soil and to the plants from below, as shown in FIGS. 2B-2C.

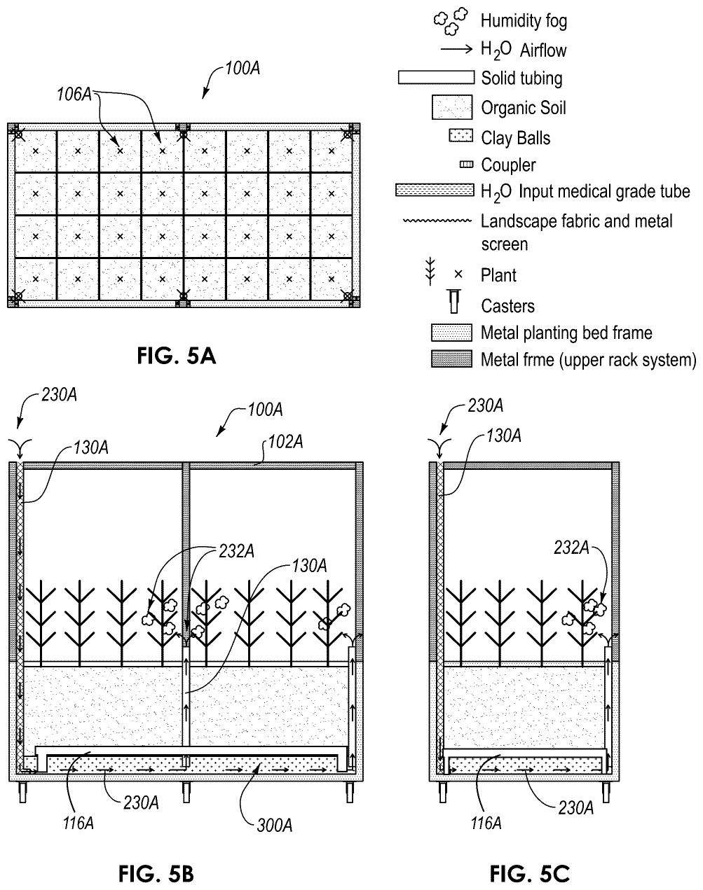

Still referring to FIGS. 2A-2C, the injected oxygen 220A consistently moving under the bed of soil keeps the soil fresh and oxygenated while preventing unwanted, anaerobic environment in the soil which causes a toxic build up within it. In particular, by keeping the TLO soil fresh and oxygenated, the microbiology within the soil allows the food web to stay alive while continuing to improve and flourish. Further, a wire-mesh liner accompanied with the installation of a landscape fabric laying on top of the soil platform 116A and clay balls can create a chamber under the bed which allows for water to travel underneath the soil. Here, the air then travels through this chamber below the soil, the moisture is evaporated through the movement of the injected air and pushed upwards into the pod's enclosed atmosphere. In addition, as shown with respect to FIGS. 5A-5C and discussed herein, as water can also be controllably injected into the chamber region 300A, the moisture and humidity can also be controlled from under the bed to further facilitate growth of the plants. Accordingly, the foregoing systems help raise the humidity and allows the space under the bed to stay free of moisture, thereby preventing unwanted toxic conditions, among other advantages.

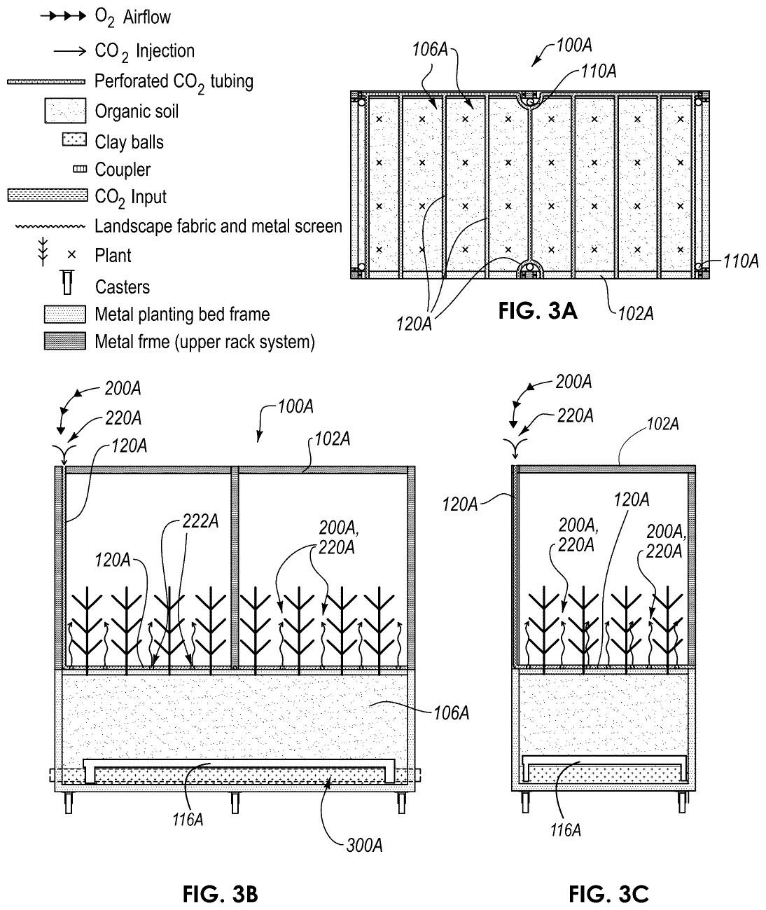

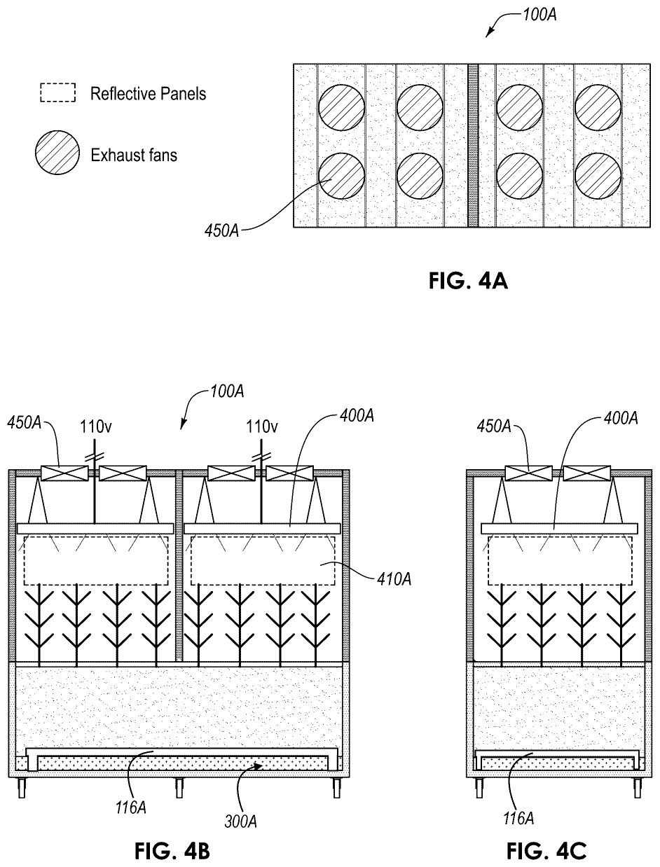

FIGS. 3A-3C illustrate the TLO system, method, and apparatus of the disclosure described herein including a vertical oxygen flow system and targeted carbon dioxide delivery and release system. Here, the TLO system and pod 100A include the TLO soil 106A with seeds and/or plants planted therein and disposed in a lower half region of the framed housing or pod. In addition, tubing 120A can be secured along the upper portion of frame 102A of the TLO system (such as along one of the vertical posts) that can allow oxygen 200A oxygen and carbon dioxide 220A to be sent or injected into the tubing via the inline fan injection system 700 and directly to the top surface region of the TLO soil where tubing 120A extends therethrough. In particular, tubing 120A can be further connected to a series of additional tubes 120A and be disposed near the surface (or on top) of the TLO soil. Here, the tubing 120A disposed laterally or substantially horizontally near the surface of the TLO soil 106A further include multiple perforations, holes, or apertures spaced apart from each other and directed towards the top (or northern direction). Specifically, as shown in FIG. 3B-3C, the perforations of tubing 120A allow the oxygen 200A and carbon dioxide gas 220A to be vertically injected from below the plants (such as via the inline fan injection system 700), in varying intervals. Here, the continuous oxygen 200A release flow and intermittent carbon dioxide 220A release flow allows for consistent exchange of fresh oxygen 200A and carbon dioxide 220A at the undersides of the plant's leaves, and which is further exhausted into the atmosphere. Here, it is contemplated within the scope of the disclosure described herein that the foregoing carbon dioxide system can co-exist and operate in combination with previously disclosed oxygen injection and circulation. In addition, the foregoing vertical O₂ flow and targeted CO₂ delivery system can also be coupled with the exhaust fan system discussed with respect to FIGS. 4A-4C. In addition, the soil platform support or lattice structure 116A may also be disposed in the cavity region 300A. For example, any type of a support platform, cross-lattice structure, porous structure, or open-pore cellular foam structure may be disposed within region 300A, such as platform 116A, that can not only support the weight of the TLO soil 106A above it, but also assist with even distributing and propagating the injected oxygen within the bottom region 300A. In addition, tubing 120A can also assist with distributing or exhausting the oxygen or carbon dioxide to the surface of the soil and to the plants, such as from below, as shown in FIGS. 3A-3C.

Still referring to FIGS. 3A-3C, the foregoing vertical oxygen flow and targeted carbon dioxide delivery system are configured to dispense or thrust oxygen and carbon dioxide in an upwards manner or direction to the underside of the leaves, where the plant absorbs the CO₂. The underside of a leaf has what's called stomata. The stomata receives and intakes (or uptakes) the CO₂ from the atmosphere as it passes by the undersides of the leaves. Further, CO₂ is heavier than oxygen which makes it fall towards the ground, thus making it difficult to get a consistent flow of CO₂ directly to the part of the plant that most needs it. To overcome this, via the carbon dioxide injection system of the disclosure described herein, the pressurized CO₂ can blow or be dispensed gently up from beneath the plants and the exhaust fans 450A (FIGS. 4A-4B), thereby to further assist with pulling the CO₂ gases up past the stomata. In nature, the normal CO₂ levels in air are around 300 to 400 parts per million (ppm). The CO₂ injection system of the disclosure described herein provides the ability to inject much higher levels of CO₂ to the stomata of the plants than would normally be possible. At certain times in their growth cycle, some plants can absorb CO₂ up to 2000 ppm, making them grow more rapidly and efficiently. So, regardless of the type of crop or where it's at in its growth cycle, the system of the disclosure described herein will allow the grower to fine tune the optimal amount of CO₂ delivered to the plant at all times. Accordingly, the foregoing carbon dioxide delivery system has been shown through experimental testing to increase plant yields by about 30-40% with a single bed of TLO soil as compared to conventional or prior art systems. Still referring to FIGS. 3A-3C, the vertical oxygen flow system can create a wind tunnel effect throughout the plant's canopy which eliminates the need for additional horizontal fans around the grow space that have conventionally been used to move air throughout the plant's canopy, thereby further improving plant yields.

FIGS. 4A-4C illustrates the TLO system, method, and apparatus of the disclosure described herein including an exhaust fan system for assisting the disclosed carbon dioxide injection system, in addition to lighting. Specifically, the housing of the TLO system and pod 100A can include multiple exhaust fans secured to the top frame section of the housing, overhead the TLO soil and plants. In operation, the exhaust fans 450A assist with pulling the injected and released CO₂ gases to the atmosphere, among others. In addition, the exhaust fans help to cool down the TLO pod's growing atmosphere by pulling colder air up through the plant canopy and out of the pod's ecosystem. The fans also help to cool down the mounted grow lights below the fans by pulling air through and around the lights. The fans can be put in reverse to blow warm air down while the lights are off in order to increase the temperature of the pod's growing atmosphere. The foregoing operations of the exhaust fans help provide the entire room full of plants with a consistent environment in which they can flourish. In effect, the exhaust fans can save about energy costs, such as about 37% in one form of experimental testing compared to conventional systems, by providing a more efficient growing atmosphere for the plants.

Still referring to FIGS. 4A-4C, the TLO pod 100A or housing may also include multiple LED type of lighting 400A suspended from the top frame section via adjustable height cables to further set at various intensities and temperatures to further facilitate plant growth. In addition, the TLO pod or housing may also include light or photon reflective panels 410A secured to the outer perimeter of the housing to further reflect light from the LED lighting to sides of the plant. Here, the light or photon reflective side panels and lighting directions may all be adjustable as well. The foregoing panels force the light or photons that would usually be lost (any light not shining directly on a plant) to be reflected back into the pod and utilized by the plant. This helps maintain the pod's atmosphere by simply hanging the about 4′×(4′, 3.5′, 3′, 2.5′, 2′, or 1.5′) side panels to one or more prefabricated notches or brackets around the outside of the pod rack's vertical posts. These notches or brackets can be spaced about 1″ apart, that can extend along the entire exterior of each rack system's vertical posts.

Still referring to FIGS. 4A-4C, the TLO system and pod 100A of the disclosure described herein also have the ability to be grouped together as multiple pods, which in effect can be used to create a larger ecosystem and atmosphere that takes less energy and resources to maintain than if the pods were all spaced apart. The light reflective/atmosphere control panels can be placed on the outside portion of the grouped pods, creating one large enclosed system. The light or photon reflective panels create a more efficient lighting system by not allowing light to escape or leak out. Here, the foregoing lighting system can allow one to obtain 20-25% more usable light on the plants inside the pod and allowing one to be much more efficient with their energy and equipment usage. Here, both the disclosed exhaust fan and lighting/reflective panel system can be used in conjunction with the previously disclosed oxygen and carbon dioxide injection systems to provide the most efficient method of growing plants. In addition, the soil platform support or lattice structure 116A may also be disposed in the cavity region 300A.

FIGS. 5A-5C illustrate the TLO system, method, and apparatus of the disclosure described herein including a moisture and humidity control system. Here, the TLO system and pod 100A includes the TLO soil 106A with seeds and/or plants planted therein and disposed in a lower half region of the framed housing or pod. In addition, tubing 130A, such as medical grade tubing, can be secured along the upper portion frame 102A of the TLO system (such as along one of the vertical posts) that can further extend to the lower portion of the frame and allow air and/or water 230A to be sent or injected into tubing 130A (as an example, in combination with injection system 700 or an alternative unit) and directly to the under bed chamber region 300A whereby the deposited air and/or water within chamber region 300A increases the moisture and humidity within the chamber. Here, tubing 130A can be further connected to series of additional tubes 130A and be directed to the surface of the TLO soil, while in fluid communication with chamber 300A. In addition, the combination of water, moisture, and humid air 232A within chamber 300A (in addition to the previously disclosed oxygen and carbon dioxide injection systems) can help with controlling such humidity levels to facilitating the growth and maintenance of micro life within the TLO soil from underneath the soil and prevent toxic conditions from developing. In addition, the combination of water, moisture, and humidity may be released to the atmosphere via the outlet regions of tubing 130A, from the bottom to the top. Specifically, the released humid air (or humidity fog) 232A can further help maintain moisture levels within each of the pods as well as facilitating plant growth. In addition, the soil platform support or lattice structure 116A may also be disposed in the cavity region 300A. It is contemplated within the scope of the present disclosure described herein that any of the pod 100A configurations shown with respect to FIGS. 2A-5C can be used alone or in combination with each other.

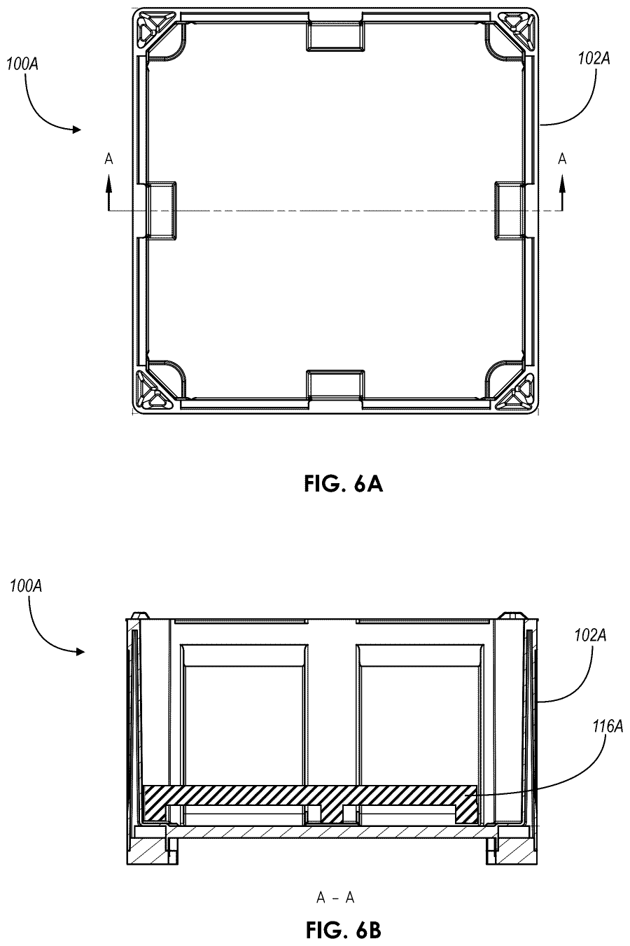

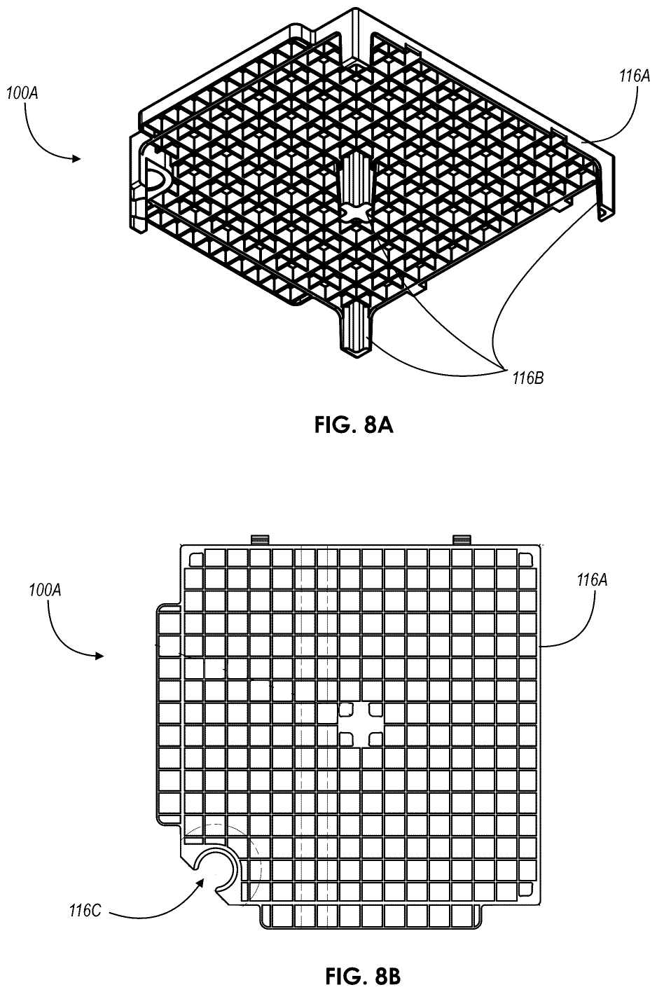

FIGS. 6A-8B illustrate in more detail pod 100A of the TLO system, method, and apparatus of the disclosure described herein. In particular, referring to FIGS. 8A-8B, soil support platform 116A is shown. Here, platform 116A generally includes a rigid grid-like, crisscross, or lattice configured type of structural configuration that can provide vertical and lateral support for the weight of soil 106A above it (FIG. 2B). In addition, platform 116A can be supported by a plurality of upright legs or supports 116B. Here, the height of platform 116A is configured to allow sufficient space underneath it for the eco-chamber 300A (FIG. 2B). In addition, platform 116A can further include an at least partially round cut-out or opening 116C in order to receive therein and accommodate at least one of tubing 108A/110A or the inline chamber fan injection system 700.

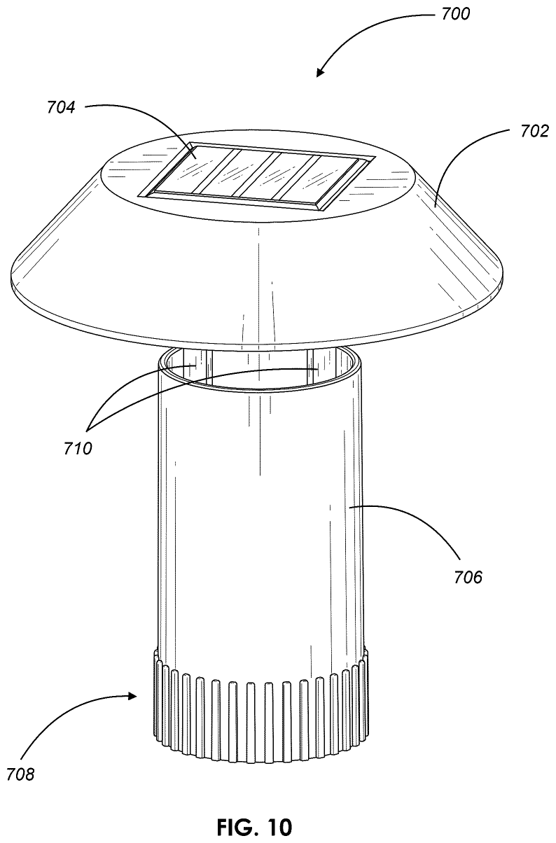

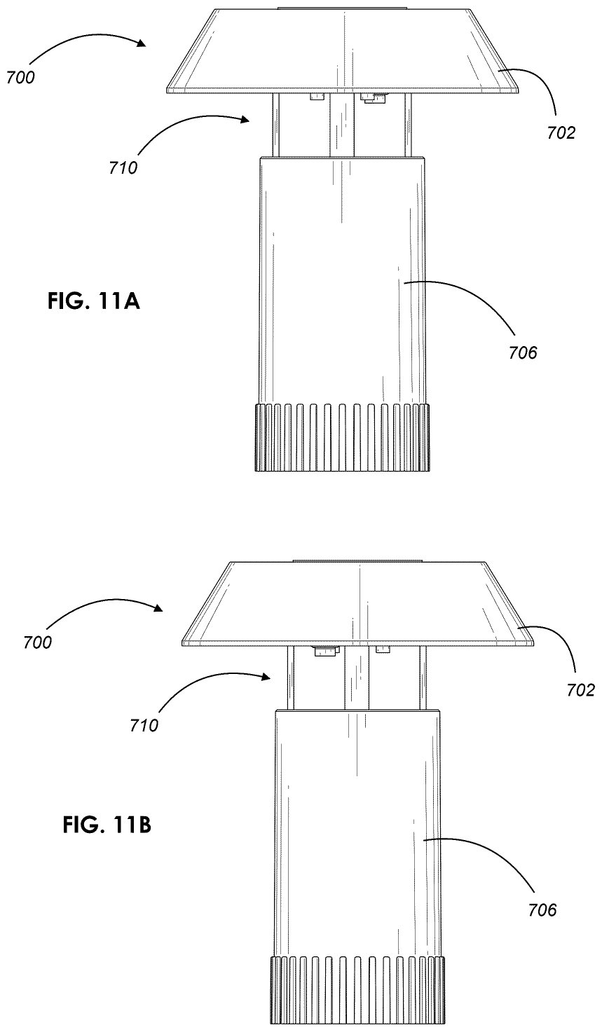

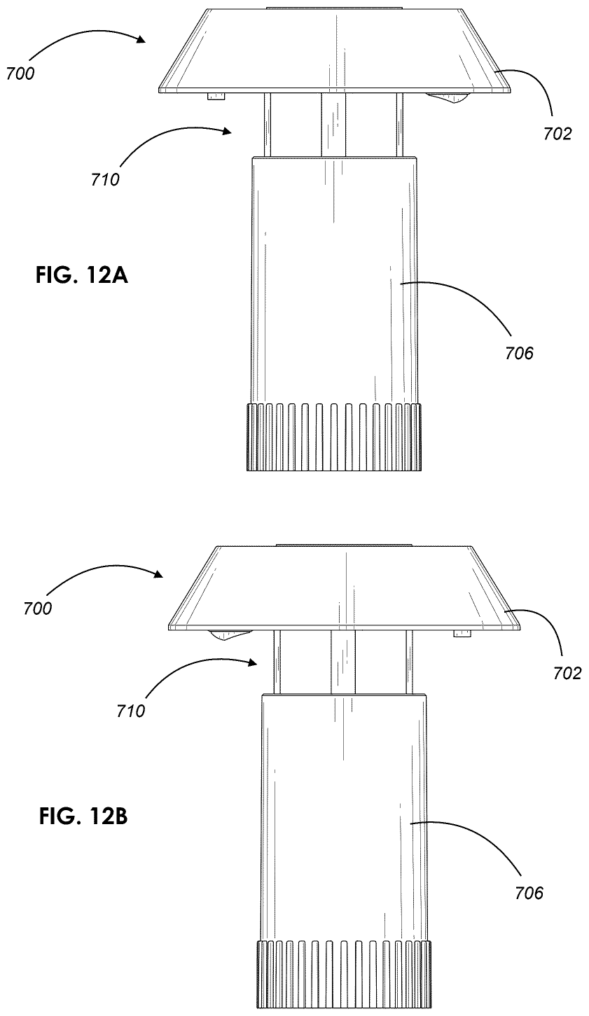

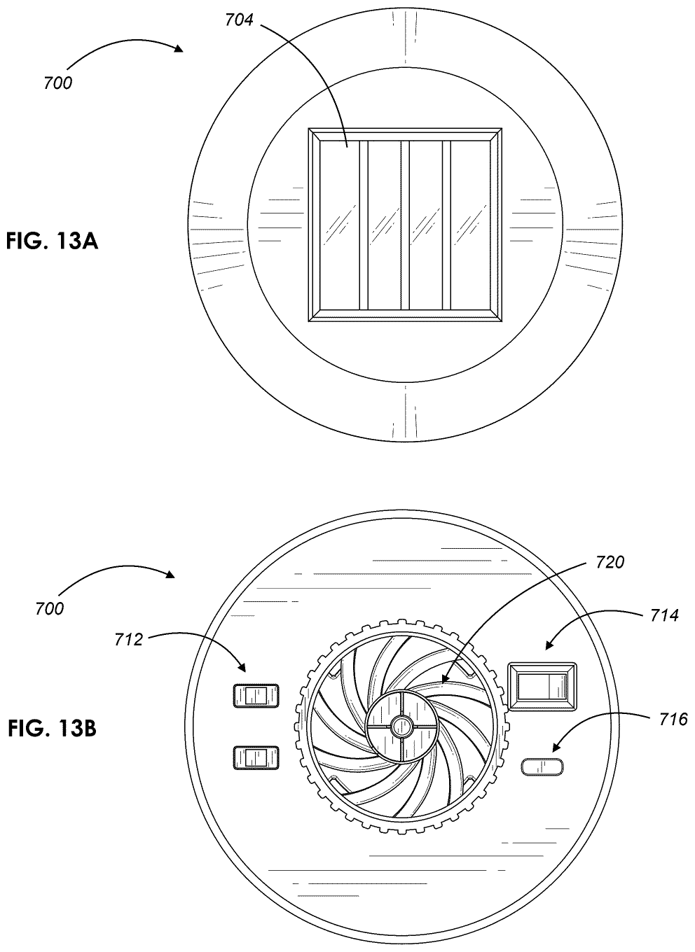

FIGS. 10-13B illustrates various views for one non-limiting exemplary embodiment of the solar inline fan injection device, unit, or system 700 of the disclosure described herein. Here, the solar inline fan injection unit 700 can include a conical-shaped top housing and cover 702 having a flat top with multiple photovoltaic cells or solar panels 704 secured thereto. In addition, cover 702 may also include various electrical components, such as an inverter for converting direct current (DC current) from solar panels 704 to alternating current (AC current), or vice versa. In addition, cover 702 may also include batteries, controller, printed circuit board (PCB), switches, memory, storage device, computing device, networking/Bluetooth/WiFi controller or interface, communication ports, power ports, charging ports, and a motor, among other components. In one embodiment, panels 704 can charge internal batteries within device 700 for operating a fan 720.

As shown in FIGS. 13B and 14B, the bottom of cover 702 may also include various speed switches 712A for configuring the fan speed, such as high and low speeds, for injecting oxygen and/or carbon dioxide into pod 100A via any of its tubing or piping as disclosed herein. In addition, cover 702 may also include a timer 712B for designating a time for running the fan of device 700, such as a 4-hour run time or turning off. However, it is contemplated within the scope of the present disclosure described herein that any number of fan speeds such as from 5 to 5000 RPM may be used, and any timer may also be used, such as from 1-minute up to and including 1-year, among others. In addition, any of the foregoing speed and timer settings may also be controlled remotely, such as via a mobile computing device or an application/app residing on a mobile computing device, among others.

Still referring to FIGS. 10-13B, solar inline fan injection device 700 can also include posts or supports 710 that secure cover 702 to a main cylindrical housing 706, which is configured to house one or more motors and a fan 720 therein adapted to inject oxygen and/or carbon dioxide into pod 100A of the disclosure described herein. Here, given the larger diameter and canopy configuration of cover 702, the cover can help to prevent rain, snow, or various debris from entering housing 706, which has open top and bottom ends to allow air to freely move therethrough. Here, fan 720 may be operated by any type of motor, which can receive its power from cover 702 and solar panels 704, including internal batteries. Alternatively, or in addition, the motors for fan 720 may also be powered via an external power source, such as via a wall outlet having 110/220 AC (among other currents), DC power source/input, batteries, hydrogen, and other renewable energy sources, such as wind and hydropower, among others. For example, if solar charging/power is unavailable, then back-up batteries may operate the fan. Here, fan 720 can be positioned in-line with the existing air tubing of pod 100A (such as any to tubing 110A, 120A, and/or 130A shown in FIGS. 1-5C), which forces air into the subsurface eco-chamber 300A through the eco tubing disclosed herein, thereby increasing air pressure and driving oxygen-rich air upward through the tubing (including its holes) both into the soil to oxygenate the base of the soil and the seeds and leaves of the plants, among others. In addition, housing 706 may include projections or grooves 708 to assist a user with gripping housing 706 for installation and removal of device 700, such as fore cleaning and/or maintenance. In addition, as shown in FIGS. 13B and 14B, fan 720 may include any type of blade design, such as from 2-blades up to 100-blades and at any angles, among other variations and configurations. Further, it is contemplated within the scope of the present disclosure described herein that any number of devices 700 can be used with pod 100A, such as one device 700 secured to a tubing of pod 100A or each tubing having its own independent device 700. As an example, in some embodiments, two or more devices 700 for a pod 100A may operate simultaneously or at separate time intervales to reach a desired oxygenation level of soil (or maintain a certain level), among other desired applications.

### Experimental Testing

Through actual experimental testing with respect to the TLO and pod 100A system of the disclosure described herein, it has been shown that by operating the fan oxygen injection device 700 via a tubing 110A (while plugging any open ended tubes, such as the three open ended tubing 110A as shown in FIG. 1), the fan oxygen injection device 700 can rapidly increase soil oxygen levels within the root zone, relative to any conventional system.

With respect to a first experimental test, an Apogee MO-200 soil oxygen sensor was used and the soil depth within pod 100A was about 12-in. A first soil oxygen sensor was placed about 1-in. above the base or bottom of the soil, and a second soil oxygen sensor was placed about 3-in. above the base or bottom of the soil. The first experiment evaluated whether device 700 could raise the oxygen concentration in the soil to atmospheric levels, or about by 20.9%, using ambient air via the fan injection device 700. The initial soil oxygen levels for the first sensor were measured at 16.9% oxygenation and for the second sensor were measured at 16.6% oxygenation. The results after 45-seconds of operating the fan of device 700 using ambient air showed a marked increase in soil oxygen at the first sensor to be at 20.8% oxygenation and at the second sensor to be at 20.4% oxygenation. Accordingly, relative to any conventional garden bed or system, the results of the first experiment demonstrated substantially increased soil oxygen levels to near-atmospheric concentrations within 45 seconds at both tested soil depths, confirming efficient air delivery throughout the lower root zone, using ambient air with device 700.

With respect to a second experimental test, the Apogee MO-200 soil oxygen sensor was used and the soil depth within pod 100A was about 12-in. For the second experimental testing, pure oxygen (such as within a pressurized oxygen capsule) was injected via device 700 into pod 100A to test whether oxygen concentration in the soil could be elevated beyond natural atmospheric levels. Here, the first soil oxygen sensor was placed about 1-in. above the base or bottom of the soil, and the second soil oxygen sensor was placed about 3-in. above the base or bottom of the soil. The initial soil oxygen levels for the first sensor were measured at 20.8% oxygenation (after the first experimental testing) and for the second sensor were measured at 20.4% oxygenation (after the first experimental testing). After 30-seconds of operating the fan of device 700 using pure oxygen, the results showed a significant increase in soil oxygen at the first sensor to be at 52.9% oxygenation and at the second sensor to be at 49.3% oxygenation. Accordingly, relative to any conventional garden bed or system, injecting pure oxygen via device 700 into pod 100A significantly boosted soil oxygen concentration above atmospheric levels in under 30 seconds. This demonstrates the system's ability not only to oxygenate, but to hyper-oxygenate the rhizosphere, which can support enhanced microbial activity, nutrient uptake, and overall plant vitality, among other advantages and improvements relative to conventional systems.

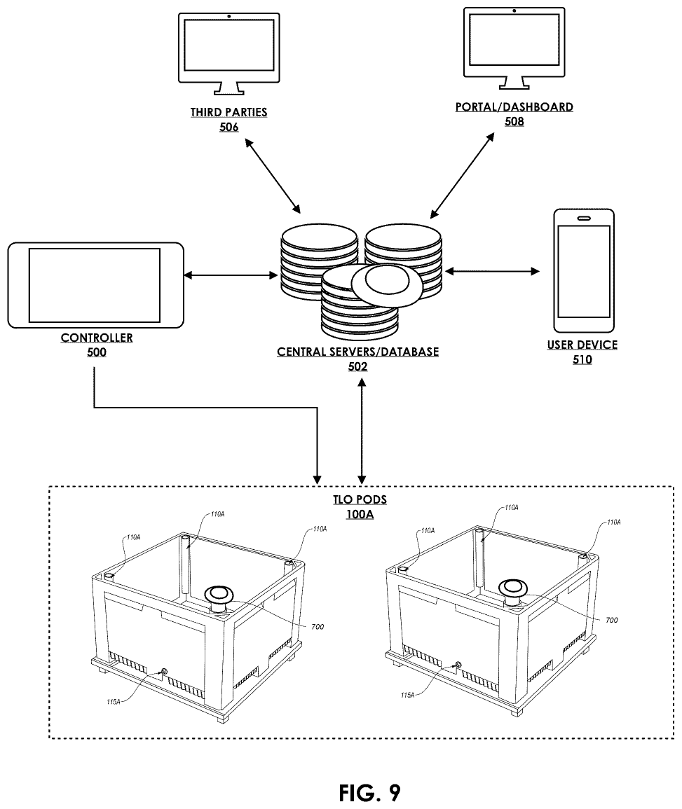

It contemplated within the scope of the present disclosure described herein that the TLO system and pod 100A may also include a wireless humidity sensor relay mounted on the rack or frame region of the pods with humidity sensing probes hung from the top middle rack/frame and suspended inside the plant canopy at optimal sensor reading heights. Here, the humidity levels can be sent wirelessly from the relay to the master control panel and the main pod monitoring computer hub, or controller 500 or servers 502 (FIG. 9). In additional, controller 50 may also manage and/or control one or more fan injection devices 700, including but not limited to operating schedules and fan speeds, among others. Here, at least one of the oxygen exhaust tubes 110A, 120A, or 130A (FIGS. 2A-5C) can have a ½ in. medical grade watering tube inserted through the tube's exhaust port that leads to the open-air chamber 300A below the soil and above the base of the bed. When the humidity control alerts the system that the humidity level needs to be increased, then the system can be programmed to release water into the open-air chamber 300A system, creating a more humid atmosphere, thereby relinquishing need for aftermarket humidifiers and the costs associated with powering them.

In addition, it is also contemplated within the scope of the present disclosure described herein that the TLO system and pod 100A may also include a watering system. Here, water entering the TLO pods, such as via sprinkler or drip, can come through a hose from overhead that plugs into the pod's watering system coupler at the edge of each pod. Further, a master controller, such as controller 500 (FIG. 9), can control the watering times and amounts based on an irrometer's moisture level readings and normal watering schedules. Here, the TLO system and controller can work with a variety of multiple irrometer soil moisture sensor systems that can wirelessly send moisture levels to the main control panel or controller 500 (FIG. 9). This allows for the gardener to make accurate watering decisions at all points during the process.

In addition, it is contemplated within the scope of the present disclosure described herein, that the TLO system and pod 100A also has the ability to hang multiple 4′×4′ bungee cord style trellis frame netting sections within the vertical post frames of the pod. The 4′×4′ trellis sections attach on each post of the pod to the trellis hook attachments located up and down the interior vertical posts. The trellis heights can be adjusted by 1-in. increments allowing for multiple trellises to be installed at various heights as the plant grows, even on the same 4′×4′ section. Here, the 4′×4′ trellis sections can be washable and reusable, which also helps save money and limits waste. Not only this, but the bungie style trellis allows for different heights within a single 4′×4′ square. Oftentimes, there can be unequal growth in plant height even within one 4′×4′ section. With the foregoing disclosed bungie design, the disclosed system can allow one to make slight adjustments to any corner of the trellis to perfectly position it to where the plant needs support most.

FIG. 9 illustrates a network architecture for an automated control system for the TLO system and pod 100A of the disclosure described herein. In particular, each TLO pod 100A may communicate bi-directionally with one or more controller units 500, wired or wirelessly via a network. Specifically, each controller can have an executable application/software/logic/code operating that allows the TLO system to be automated or function via pre-defined user settings. For example, a user may be able to define various parameters and schedules, fan operation and fan speeds for device 700, humidity levels, oxygen levels, carbon dioxide level, watering time, lighting time, among others, for each individual pod for the TLO system 100A. Alternatively, the controller may operate various electro-mechanical or solenoid devices, such as valves, to release water, oxygen, and carbon dioxide within each pod for a pre-defined period (or based on real-time sensor readings and/or input to the controller). In addition, the controller 500 or each pod 100A may further communicate or transmit data/information to a central system 502 for logging, storing, or managing various information. For example, the central servers may host data in the “cloud,” such as via Amazon Web Services (AWS) and be accessed via either the controller 500, a portal/dashboard 508, or various third parties 506. In addition, a user device 510, such as a mobile phone, may also have a dedicated “app” that can allow it to communicate with servers 502, controller 500, or directly with each of the pods 100A, such as to retrieve real-time sensor data for each of the pods or operate various control parameters (e.g., watering the plants), among other advantages.

Here it is contemplated within the scope of the present disclosure described herein that any of the components, parts, features, or elements disclosed with respect to FIGS. 1-14B of pod 100A, including but not limited to features 100A-510, can be used in combination with each other as one embodiment or alternative embodiments of the disclosure described herein.

From the foregoing it will be seen that the present disclosure described herein is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts described herein, except insofar as such limitations are included in following claims. Further, it will be understood that certain features and sub-combinations are of utility and may be employed without reference to other features and sub-combinations. This contemplated by and is within the scope of the claims.

What is claimed is:

1. A true living organic system, comprising:
a housing adapted to receive soil and one or more plants or seeds therein, wherein the housing comprises a floor region;
a support platform above the floor region of the housing, such that the platform comprises an open aerated region there below; and
a fan unit secured to a tubing that extends from an upper region of the housing, wherein the fan unit is adapted to inject oxygen into the tubing.

2. The system of claim 1, wherein the tubing is comprised of a plurality of tubes that further extend to a lower region of the housing.

3. The system of claim 1, further comprising a circulation fan module, wherein the circulation fan module is configured to divert carbon dioxide gases.

4. The system of claim 1, wherein the fan unit comprises one or more solar panels or photovoltaic cells.

5. The system of claim 1, wherein the support platform is comprised of a grid or lattice configuration.

6. The system of claim 1, wherein the support platform further comprises an opening adapted to receive the tubing.

7. The system of claim 1, further comprising a controller in communication with the housing.

8. The system of claim 7, wherein the controller is configured to release water, oxygen, or carbon dioxide for a pre-defined period.
